(19) United States
(12) Patent Application Publication
(10) Pub. No.: US 2026/0288609 A1
(43) Pub. Date: Sep. 24, 2026

(54) METHOD FOR OBTAINING SENSOR DATA

(71) Applicant: Jabil Circuit (Singapore) Pte. Ltd., Singapore (SG)

(72) Inventors: Ping-Han Hsieh, Taichung City (TW); Jen Huang, Taichung City (TW); Po-Hsun Hu, New Taipei City (TW)

(73) Assignee: Jabil Circuit (Singapore) Pte. Ltd., Singapore (SG)

(21) Appl. No.: 19/364,352

(22) Filed: Oct. 21, 2025

(30) Foreign Application Priority Data
Mar. 20, 2025 (CN) 202510335999.3

(51) Int. Cl. G06F 11/22

(52) U.S. Cl. CPC G06F 11/2284

(57) ABSTRACT

A method is provided for obtaining sensing data pieces respectively of sensors that correspond respectively to multiple to-be-detected devices plugged into slots of a motherboard. The method is implemented by a controller storing a lookup table and a sensor data record file, and includes steps of, for each to-be-detected device: obtaining an entry of to-be-detected information that corresponds to the to-be-detected device; obtaining an entry of sensor information that corresponds to the entry of to-be-detected device identification information based on the entry of to-be-detected information and the lookup table; sending a sensor reading request to the to-be-detected device; and upon receiving sensor feedback data from the to-be-detected device, obtaining a target to-be-detected sensing value based on the sensor feedback data and the entry of sensor information, and using the target to-be-detected sensing value as a sensing data piece that corresponds to the slot into which the to-be-detected device is plugged.

### CROSS-REFERENCE TO RELATED APPLICATION

This application claims priority to Chinese Invention Patent Application No. 202510335999.3, filed on Mar. 20, 2025, the entire disclosure of which is incorporated by reference herein.

### FIELD

The disclosure relates to a method for monitoring a device disposed on a motherboard, and more particularly to a method for obtaining sensor data that corresponds to the device disposed on the motherboard.

### BACKGROUND

Different external devices (e.g., network cards, redundant array of independent disks (RAID), graphic processing unit (GPU)) may be installed on a server platform according to specific user needs. A baseboard management controller (BMC) is an independent management controller installed on a motherboard of the server platform, and may operate independently of the operating system of the server platform and be connected to a remote management network of the server platform via an independent network card. The BMC is configured to monitor a type and sensing data of the devices through an Intelligent Platform Management Interface (IPMI) sensor data record (SDR). For a server platform with multiple combinations of different devices, a plurality of SDR files (e.g., see FIG. 5, blocks 501, 502, and 503) corresponding respectively to the combinations of devices are required. One single SDR file cannot be used to represent different combinations of devices because the SDR files represent sensors in a device-oriented manner. Each combination would have different device types, quantities, and slots (e.g., PCIe or OCP slots), so the SDR files would differ from each other. Therefore, as the number of devices increases, the number of SDR files that need to be created to represent the different combinations would also increase, leading to an increase in code size, which further increases the complexity of a project, making the project difficult to maintain.

### SUMMARY

Therefore, an object of the disclosure is to provide a method for obtaining a plurality of sensing data pieces respectively of a plurality of sensors that can alleviate at least one of the drawbacks of the prior art.

According to the disclosure, a method for obtaining a plurality of sensing data pieces respectively of a plurality of sensors that correspond respectively to a plurality of to-be-detected devices disposed on a motherboard is provided. The method is to be implemented by a controller that is disposed on the motherboard. The motherboard includes a plurality of slots, with each of the to-be-detected devices being plugged into one of the slots. The controller stores a lookup table and a sensor data record file that includes multiple entries of slot identification information related respectively to the slots, and multiple entries of virtual sensor identification information respectively of a plurality of virtual sensors respectively for monitoring the slots. The method includes, for each to-be-detected device, steps of: obtaining an entry of to-be-detected information that corresponds to the to-be-detected device, where the entry of to-be-detected information includes an entry of to-be-detected device identification information of the to-be-detected device, and an entry of to-be-detected slot identification information related to one of the slots into which the to-be-detected device is plugged; and performing a processing procedure. The processing procedure includes: based on the entry of to-be-detected device identification information included in the entry of to-be-detected information, and the lookup table that includes multiple entries of configuration device identification information related respectively to a plurality of configuration devices, and multiple entries of sensor information corresponding respectively to the multiple entries of configuration device identification information, obtaining one of the entries of sensor information that corresponds to one of the entries of configuration device identification information which conforms with the entry of to-be-detected device identification information, wherein each of the entries of sensor information included in the lookup table is related to at least one sensor that is disposed on a corresponding one of the configuration devices, and includes at least one entry of sensor identification information that is related respectively to the at least one sensor and an entry of operation processing data for processing a sensing value of the at least one sensor; sending a sensor reading request to the to-be-detected device, and in response to receiving sensor feedback data from the to-be-detected device, where the sensor feedback data includes at least one to-be-detected sensing value respectively of at least one to-be-detected sensor disposed in the to-be-detected device, obtaining a target to-be-detected sensing value based on the at least one to-be-detected sensing value and the entry of operation processing data included in the one of the entries of sensor information that corresponds to the entry of to-be-detected device identification information of the to-be-detected device, and using the target to-be-detected sensing value as a sensing data piece of one of the virtual sensors that corresponds to one of the slots into which the to-be-detected device is plugged.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a controller and a plurality of to-be-detected devices according to an embodiment of the disclosure.

FIG. 2 is a flow chart illustrating a method for obtaining a plurality of sensing data pieces respectively of a plurality of sensors according to an embodiment of the disclosure.

FIG. 3 is a flow chart illustrating sub-steps of obtaining an entry of to-be-detected information according to the method.

FIG. 4 is a flow chart illustrating sub-steps of obtaining a target to-be-detected sensing value according to the method.

FIG. 5 is a schematic diagram illustrating a plurality of sensor data record files for a combination of different devices according to a prior art.

FIG. 6 is a schematic diagram illustrating a sensor data record file of this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

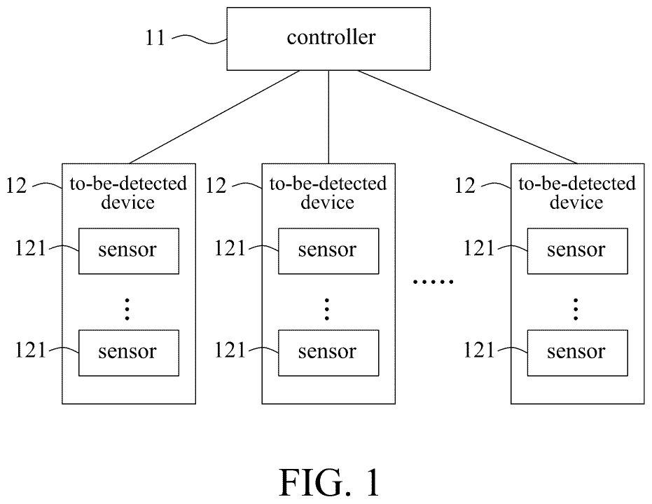

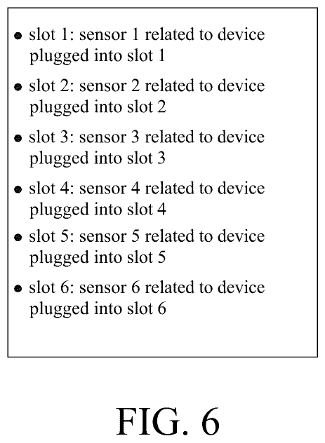

Referring to FIG. 1, according to an embodiment of the disclosure, there is provided a method for obtaining a plurality of sensing data pieces respectively of a plurality of sensors 121 that correspond to a plurality of to-be-detected devices 12 disposed on a motherboard (not shown). The method is implemented by a controller 11 that is disposed on the motherboard and that is electrically connected to the to-be-detected devices 12. The motherboard includes a plurality of slots, with each of the to-be-detected devices 12 being plugged into one of the slots. In this embodiment, the controller 11 is implemented as a baseboard management controller (BMC), but the disclosure is not limited to such. The controller 11 stores a sensor data record (SDR) file and a lookup table. The SDR file includes multiple entries of slot identification information related respectively to the slots, and multiple entries of virtual sensor identification information respectively of a plurality of virtual sensors respectively for monitoring the slots. Specifically, the virtual sensors recorded in the SDR file are recorded in a slot-oriented manner; for example, as shown in FIG. 6, the SDR file indicates which virtual sensor is plugged into which slot. The lookup table includes multiple entries of configuration device identification information related respectively to a plurality of configuration devices, and multiple entries of sensor information corresponding respectively to the entries of configuration device identification information. To describe in further detail, the configuration devices are possible types of the to-be-detected devices 12 that may be plugged into the slots, and each configuration device has a unique identification indicated by the corresponding entry of configuration device identification information. In one example, the configuration device may be a graphic card, a memory card, etc., and the corresponding entry of configuration device identification information would indicate that the configuration device is a graphic card, a memory card, etc. Each entry of sensor information included in the lookup table is related to at least one sensor that is generally used to monitor the corresponding configuration device, and includes at least one entry of sensor identification information that is related respectively to the at least one sensor and an entry of operation processing data for processing the sensing value of the at least one sensor of the corresponding configuration device. Each entry of operation processing data includes at least one calibration parameter that corresponds respectively to the at least one sensor, a general normal threshold that corresponds to all of the at least one sensor, and a general normalization parameter that corresponds to all of the at least one sensor.

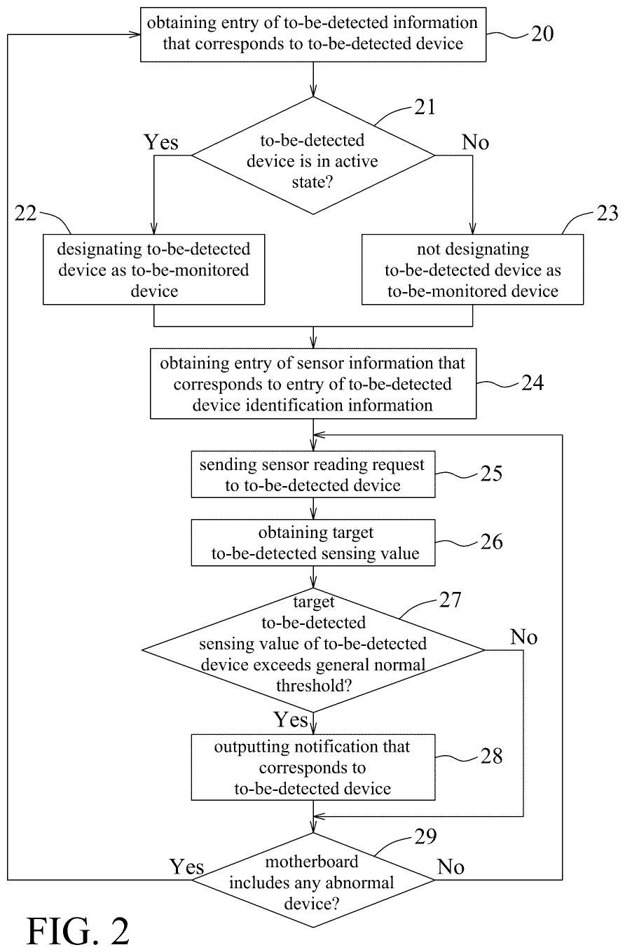

Referring further to FIG. 2, details of the controller 11 implementing the method is described in the following. In this embodiment, the method includes steps 20 to 29. Since steps 20 to 28 of the method are performed for each of the to-be-detected devices 12, only one of the to-be-detected devices 12 will be described in detail in the following.

In step 20, the controller 11 obtains an entry of to-be-detected information that corresponds to the to-be-detected device 12. The entry of to-be-detected information includes an entry of to-be-detected device identification information of the to-be-detected device 12, and an entry of to-be-detected slot identification information related to one of the slots into which the to-be-detected device 12 is plugged.

To describe in further detail, the entry of to-be-detected device identification information of the to-be-detected device 12 may be used by the controller 11 for identifying a type of the to-be-detected device 12 according to content of the lookup table. Specifically, the controller 11 identifies one of the entries of configuration device identification information that conforms with the entry of to-be-detected device identification information, so as to determine the type of the to-be-detected device 12.

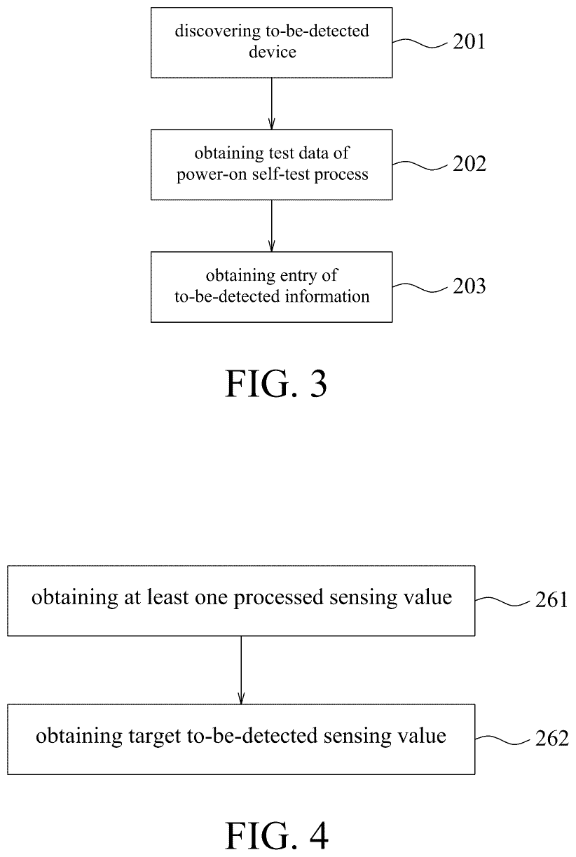

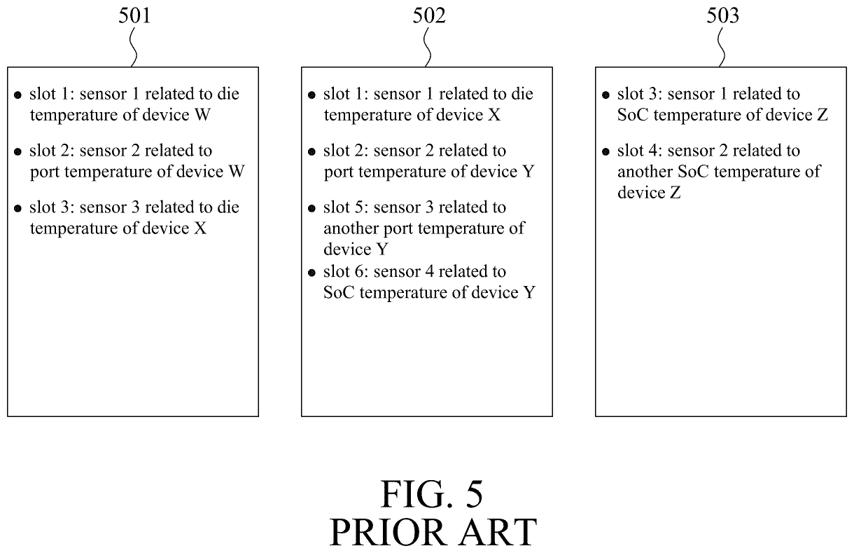

It should be noted that step 20 includes sub-steps 201 to 203 (see FIG. 3).

In sub-step 201, the controller 11 discovers the to-be-detected device 12 through a standard protocol. Since the technical feature of this disclosure is not related to the device discovery technology used by the controller 11, details thereof will not be described in further detail for the sake of brevity.

In sub-step 202, the controller 11 obtains test data related to a power-on self-test process that is handled by a basic input/output system (BIOS) for the to-be-detected device 12.

In sub-step 203, the controller 11 obtains the entry of to-be-detected information based on the test data. Specifically, the power-on self-test process is for checking whether hardware devices on the motherboard have any issues before the BIOS loads the operating system, and the test data is generated based on a result of the power-on self-test process. The test data records information about all detected hardware devices, which include the to-be-detected device 12 discovered by the controller 11 in sub-step 201. As such, the controller 11 may obtain the entry of to-be-detected information based on the test data.

In step 21, the controller 11 determines whether the to-be-detected device 12 is in an active state. When the controller 11 determines that the to-be-detected device 12 is in the active state, the flow of the method proceeds to step 22; otherwise, the flow proceeds to step 23. It should be noted that the controller 11 may determine whether the to-be-detected device 12 is in the active state by sending a query to the to-be-detected device 12, and then determining whether a response to the query is received from the to-be-detected device 12.

In step 22, the controller 11 designates the to-be-detected device 12 as a to-be-monitored device.

In step 23, the controller 11 does not designate the to-be-detected device 12 as a to-be-monitored device.

Then, the controller 11 performs a processing procedure (steps 24 to 28) for each to-be-detected device 12 that is designated as a to-be-monitored device.

In step 24, the controller 11, based on the entry of to-be-detected device identification information that is included in the entry of to-be-detected information and the lookup table that is stored in the controller 11, obtains one of the entries of sensor information that corresponds to the entry of to-be-detected device identification information. Specifically, the controller 11 uses the lookup table to first identify one of the entries of configuration device identification information that conforms with the entry of to-be-detected device identification information, and then obtain one of the entries of sensor information that corresponds to that one of the entries of configuration device identification information.

In step 25, the controller 11 sends a sensor reading request through the standard protocol to the to-be-detected device 12 (i.e., the to-be-monitored device designated in step 22).

In step 26, when the controller 11 receives sensor feedback data from the to-be-detected device 12, where the sensor feedback data includes at least one to-be-detected sensing value respectively of at least one of the sensors 121 disposed in the to-be-detected device 12 (herein after referred to as “at least one to-be-detected sensor 121”), the controller 11 obtains a target to-be-detected sensing value based on the at least one to-be-detected sensing value and the entry of operation processing data included in the entry of sensor information that is obtained in step 24 and that corresponds to the entry of to-be-detected device identification information of the to-be-detected device 12. The controller 11 then uses the target to-be-detected sensing value as a sensing data piece of one of the virtual sensors that corresponds to one of the slots into which the to-be-detected device 12 is plugged. It should be noted that after obtaining the sensing data piece of any virtual sensor, the controller 11 stores that sensing data piece into the SDR file. As such, the SDR file would further include a plurality of sensing data pieces respectively of the virtual sensors.

It should be noted that the entry of sensor information (obtained in step 24) corresponding to the entry of the configuration device identification information that corresponds to the entry of to-be-detected device identification information indicates information related to the at least one to-be-detected sensor 121 disposed in the to-be-detected device 12.

It should be noted that step 26 includes sub-steps 261 and 262 (see FIG. 4).

In sub-step 261, upon receiving the sensor feedback data from the to-be-detected device 12, the controller 11, based on the entry of operation processing data, performs computation on the at least one to-be-detected sensing value to obtain at least one processed sensing value, respectively. Specifically, for each to-be-detected sensing value, the computation is performed based on one of the at least one calibration parameter that corresponds to the corresponding to-be-detected sensor 121 from which the to-be-detected sensing value is obtained, and the general normalization parameter that corresponds to all of the at least one to-be-detected sensor 121 of the to-be-detected device 12, using an equation as follows:

$${S}_{Normalization} = S - TJ MAX + Normalize number ,$$

where “S” represents the to-be-detected sensing value, “TJMAX” represents the calibration parameter of the corresponding to-be-detected sensor 121, “Normalize number” represents the general normalization parameter that corresponds to all of the at least one to-be-detected sensor 121 of the to-be-detected device 12, and “S_{Normalization}” represents the processed sensing value.

In sub-step 262, the controller 11 obtains the target to-be-detected sensing value based on the at least one processed sensing value that corresponds to the to-be-detected device 12, and uses the target to-be-detected sensing value as the sensing data piece as described in step 26.

In one example, each to-be-detected sensing value represents a temperature value, and the at least one to-be-detected sensing value includes a value of chipset temperature and a value of port temperature. Since the upper and lower temperature thresholds for temperature of a chipset and temperature of a port would be different, the processed sensing values (i.e., temperature values) respectively of the chipset and the port may be normalized through the abovementioned computation in sub-step 261. Then, a maximum one of the at least one processed sensing value (e.g., the highest temperature value) is used as the target to-be-detected sensing value to represent the sensing data piece of the to-be-detected device 12.

In step 27, the controller 11 determines whether the target to-be-detected sensing value of the to-be-detected device 12 exceeds the general normal threshold included in the entry of operation processing data of the entry of sensor information (obtained in step 24). When the controller 11 determines that the target to-be-detected sensing value of the to-be-detected device 12 exceeds the general normal threshold, the flow proceeds to step 28; otherwise, the flow proceeds to step 29.

In step 28, the controller 11 outputs a notification that corresponds to the to-be-detected device 12. In one example, the controller 11 generates and displays a warning message that corresponds to the to-be-detected device 12 on a screen (not shown) for warning. In another example, the controller 11 generates and stores the warning message in a record, which may be viewed by an administrator at a later time. In yet another example, the controller 11 generates and sends the warning message to the administrator directly.

In step 29, the controller 11 determines whether the motherboard includes any abnormal device. In some embodiments, the abnormal device (e.g., a hot-removed device) may be identified when the controller 11 sends a signal to the to-be-detected device 12, but the to-be-detected device 12 does not respond to the signal, but the disclosure is not limited to such. In some embodiments, the abnormal device (e.g., a hot-inserted device) may be identified by the controller 11 periodically performing discovery (similar to sub-step 201) through the standard protocol. In one example, each abnormal device may be a hot-inserted device, a hot-removed device, or a crashed device. When the controller 11 determines that the motherboard includes at least one abnormal device, the flow returns to step 20; otherwise, the flow returns to step 25. It should be noted that step 29 may be performed at any time after step 20, and may be performed periodically.

In summary, by making the SDR file record the virtual sensors in a slot-oriented manner, the SDR file stored in the controller 11 may be used to record a combination of different devices on the motherboard. Furthermore, by obtaining the target to-be-detected sensing value of the to-be-detected device 12, and using the target to-be-detected sensing value as the sensing data piece of one of the virtual sensors that corresponds to one of the slots into which the to-be-detected device 12 is plugged, the sensing data piece of the to-be-detected device 12 may be periodically updated. Since the SDR file stored in the controller 11 may be used for a combination of different devices, for a platform server that is installed with multiple devices, the controller 11 of the platform server may store just one SDR file for monitoring the server platform, which significantly reduces a size of a program code of a project on the platform server. Moreover, when plugging in additional devices onto the motherboard, there is no need to update a firmware of the controller (e.g., a firmware of the BMC) for constructing a new SDR file, which also reduces the size of the program code of the project. Furthermore, the reading of the sensing value of the sensor 121 and the listing of the sensing data piece of the virtual sensor may be achieved using “Get Sensor Reading” and “sensor list” commands of the existing IPMItool, without the need to write a new firmware for achieving these functions.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for obtaining a plurality of sensing data pieces respectively of a plurality of sensors that correspond to a plurality of to-be-detected devices disposed on a motherboard, the method to be implemented by a controller that is disposed on the motherboard, the motherboard including a plurality of slots, where each of the plurality of to-be-detected devices is plugged into one of the plurality of slots, the controller storing a sensor data record (SDR) file that includes multiple entries of slot identification information related respectively to the plurality of slots and multiple entries of virtual sensor identification information respectively of a plurality of virtual sensors respectively for monitoring the plurality of slots, the method comprising, for each to-be-detected device of the plurality of to-be-detected devices, steps of:
obtaining an entry of to-be-detected information that corresponds to the to-be-detected device, where the entry of to-be-detected information includes an entry of to-be-detected device identification information of the to-be-detected device, and an entry of to-be-detected slot identification information related to one of the plurality of slots into which the to-be-detected device is plugged; and
performing a processing procedure that includes
based on the entry of to-be-detected device identification information included in the entry of to-be-detected information, and a lookup table that includes multiple entries of configuration device identification information related respectively to a plurality of configuration devices, and multiple entries of sensor information corresponding respectively to the multiple entries of configuration device identification information, obtaining, from the lookup table, one of the entries of sensor information that corresponds to one of the entries of configuration device identification information which conforms with the entry of to-be-detected device identification information, wherein each of the entries of sensor information included in the lookup table is related to at least one sensor that is used to monitor a corresponding one of the plurality of configuration devices, and includes at least one entry of sensor identification information that is related respectively to the at least one sensor and an entry of operation processing data for processing a sensing value of the at least one sensor,
sending a sensor reading request to the to-be-detected device, and
in response to receiving sensor feedback data from the to-be-detected device, where the sensor feedback data includes at least one to-be-detected sensing value respectively of at least one to-be-detected sensor disposed in the to-be-detected device, obtaining a target to-be-detected sensing value based on the at least one to-be-detected sensing value and the entry of operation processing data included in said one of the entries of sensor information that corresponds to the entry of to-be-detected device identification information of the to-be-detected device, and using the target to-be-detected sensing value as a sensing data piece of one of the plurality of virtual sensors that corresponds to one of the plurality of slots into which the to-be-detected device is plugged.

2. The method as claimed in claim 1, wherein the step of obtaining an entry of to-be-detected information includes:
discovering the to-be-detected device;
obtaining test data related to a power-on self-test process that is handled by a basic input/output system (BIOS) for the to-be-detected device; and
obtaining the entry of to-be-detected information based on the test data.

3. The method as claimed in claim 1, wherein obtaining a target to-be-detected sensing value includes:
upon receiving the sensor feedback data from the to-be-detected device, based on the entry of operation processing data, performing computation on the at least one to-be-detected sensing value to obtain at least one processed sensing value, respectively; and
based on the at least one processed sensing value that corresponds to the to-be-detected device, obtaining the target to-be-detected sensing value.

4. The method as claimed in claim 3, wherein the entry of operation processing data includes at least one calibration parameter that corresponds respectively to the at least one sensor, and a general normalization parameter that corresponds to all of the at least one sensor.

5. The method as claimed in claim 4, wherein performing computation on the at least one to-be-detected sensing value includes, for each to-be-detected sensing value of the at least one to-be-detected sensing value, obtaining the processed sensing value based on one of the at least one calibration parameter that corresponds to a corresponding one of the at least one to-be-detected sensor and the general normalization parameter that corresponds to all of the at least one to-be-detected sensor of the to-be-detected device, and using an equation as follows:
$${S}_{Normalization} = S - TJ MAX + Normalize number ,$$
where “S” represents the to-be-detected sensing value, “TJMAX” represents the calibration parameter of the corresponding one of the at least one to-be-detected sensor, “Normalize number” represents the general normalization parameter that corresponds to all of the at least one to-be-detected sensor of the to-be-detected device, and “S_{Normalization}” represents the processed sensing value.

6. The method as claimed in claim 4, wherein the entry of operation processing data further includes a general normal threshold that corresponds to the at least one sensor, and the processing procedure further includes, after obtaining the target to-be-detected sensing value:
determining whether the target to-be-detected sensing value of the to-be-detected device exceeds the general normal threshold included in the entry of operation processing data of said one of the entries of sensor information; and
in response to determining that the target to-be-detected sensing value of the to-be-detected device exceeds the general normal threshold, outputting a notification that corresponds to the to-be-detected device.

7. The method as claimed in claim 6, after the step of obtaining an entry of to-be-detected information, and before the step of performing a processing procedure, the method further comprising, for each to-be-detected device of the plurality of to-be-detected devices:
determining whether the to-be-detected device is in an active state; and
in response to determining that the to-be-detected device is in the active state, designate the to-be-detected device as a to-be-monitored device;
wherein the processing procedure is performed for each of the to-be-detected devices that is designated as the to-be-monitored device.

8. The method as claimed in claim 1, further comprising:
determining whether the motherboard includes any abnormal device; and
in response to determining that the motherboard includes at least one abnormal device, implementing the steps of obtaining an entry of to-be-detected information and performing a processing procedure.

9. The method as claimed in claim 8, further comprising:
in response to determining that the motherboard does not include any abnormal device, sending the sensor reading request to each of the plurality of to-be-detected devices.
